(19) United States
(12) Patent Application Publication
(10) Pub. No.: US 2021/0212516 A1
(43) Pub. Date: Jul. 15, 2021

(54) Gas Grill Charcoal Holder

(71) Applicant: Kenn Kinnaird, Lacey, WA (US)

(72) Inventor: Kenn Kinnaird, Lacey, WA (US)

(21) Appl. No.: 16/742,488

(22) Filed: Jan. 14, 2020

(51) Int. Cl. A47J 37/07; F24B 15/04

(52) U.S. Cl. CPC A47J 37/0786; A47J 37/0704; F24B 15/04

(57) ABSTRACT

A gas grill charcoal holder for using charcoal with a gas grill includes a plurality of mounting rods and a pair of charcoal supports. Each of the plurality of mounting rods has a central engagement portion and a pair of lateral support portions. The central engagement portion is configured to selectively engage a burner heat shield of a gas grill. The pair of charcoal supports is coupled to the pair of lateral support portions of each of the plurality of mounting rods. Each of the pair of charcoal supports is configured to hold a plurality of charcoal briquettes.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to charcoal holders and more particularly pertains to a new charcoal holder for using charcoal with a gas grill.

### BRIEF SUMMARY OF THE INVENTION

An embodiment of the disclosure meets the needs presented above by generally comprising a plurality of mounting rods and a pair of charcoal supports. Each of the plurality of mounting rods has a central engagement portion and a pair of lateral support portions. The central engagement portion is configured to selectively engage a burner heat shield of a gas grill. The pair of charcoal supports is coupled to the pair of lateral support portions of each of the plurality of mounting rods. Each of the pair of charcoal supports is configured to hold a plurality of charcoal briquettes.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a gas grill charcoal holder according to an embodiment of the disclosure.

FIG. 2 is a front elevation view of an embodiment of the disclosure.

FIG. 3 is a bottom plan view of an embodiment of the disclosure.

FIG. 4 is a side elevation view of an embodiment of the disclosure.

FIG. 5 is an in-use view of an embodiment of the disclosure.

### DETAILED DESCRIPTION OF THE INVENTION

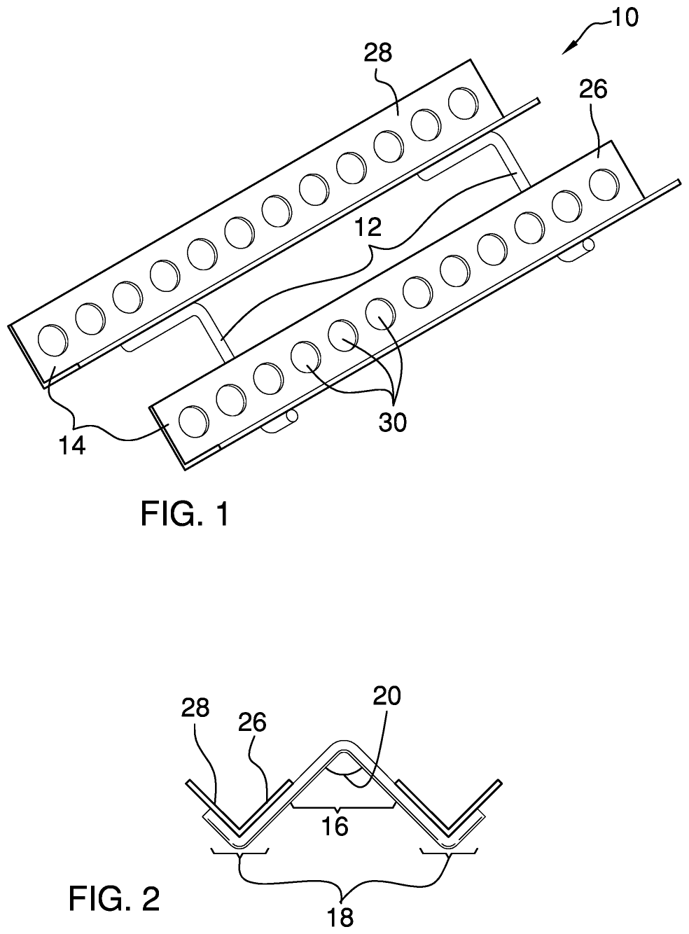

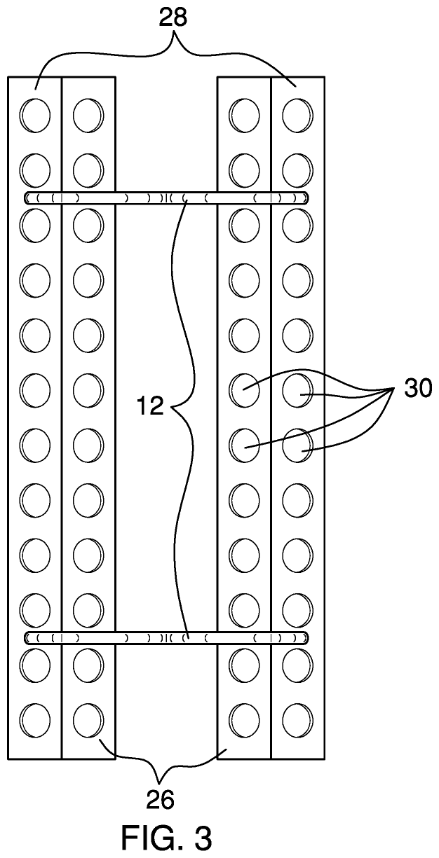

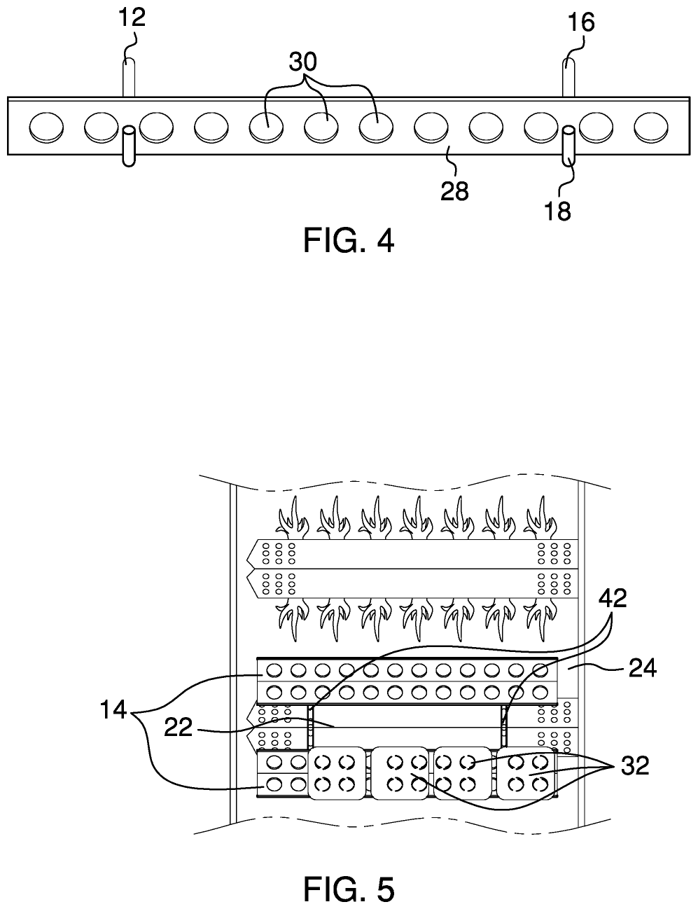

With reference now to the drawings, and in particular to FIGS. 1 through 5 thereof, a new charcoal holder embodying the principles and concepts of an embodiment of the disclosure and generally designated by the reference numeral 10 will be described.

As best illustrated in FIGS. 1 through 5, the gas grill charcoal holder 10 generally comprises a plurality of mounting rods 12 and a pair of charcoal supports 14. Each of the plurality of mounting rods 12 may be W-shaped. Each of the plurality of mounting rods 12 has a central engagement portion 16 and a pair of lateral support portions 18. The central engagement portion 16 may form a right angle 20 and is configured to selectively engage a burner heat shield 22 of a gas grill 24. The pair of charcoal supports 14 is coupled to the pair of lateral support portions 18 of each of the plurality of mounting rods. Each of the pair of charcoal supports 14 has an internal side 26 and an external side 28. Each of the pair of charcoal supports 14 may be V-shaped with the internal side 26 perpendicular the external side 28. Each of the internal side 26 and the external side 28 may have a plurality of perforations 30 to allow flames from the gas grill 24 to come through. Each of the plurality of perforations 30 may be circular and the plurality of perforations may be colinearly aligned. Each of the pair of charcoal supports 14 is configured to hold a plurality of charcoal briquettes 32 between the internal side 26 and the external side 28.

In use, the plurality of mounting rods 12 is placed on the burner heat shield 22 and a plurality of briquettes 32 is placed on the pair of charcoal supports 14. The gas grill 24 is then ignited to light the plurality of briquettes 32. Once lit, the gas grill 24 may be turned down.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A gas grill charcoal holder comprising:
a plurality of mounting rods, each of the plurality of mounting rods having a central engagement portion and a pair of lateral support portions, the central engagement portion being configured to selectively engage a burner heat shield of a gas grill; and
a pair of charcoal supports coupled to each of the plurality of mounting rods, the pair of charcoal supports being coupled to the pair of lateral support portions, each of the pair of charcoal supports being configured to hold a plurality of charcoal briquettes.

2. The gas grill charcoal holder of claim 1 further comprising each of the pair of charcoal supports being V-shaped, each of the pair of charcoal supports having an internal side and an external side.

3. The gas grill charcoal holder of claim 2 further comprising each of the pair of charcoal supports being V-shaped with the internal side perpendicular the external side.

4. The gas grill charcoal holder of claim 2 further comprising each of the internal side and the external side having a plurality of perforations.

5. The gas grill charcoal holder of claim 4 further comprising each of the plurality of perforations being circular, the plurality of perforations being colinearly aligned.

6. The gas grill charcoal holder of claim 2 further comprising each of the plurality of mounting rods being W-shaped.

7. The gas grill charcoal holder of claim 6 further comprising the central engagement portion forming a right angle.

8. The gas grill charcoal holder of claim 1 further comprising the plurality of mounting rods being two mounting rods.

9. A gas grill charcoal holder comprising:
a plurality of mounting rods, each of the plurality of mounting rods being W-shaped, each of the plurality of mounting rods having a central engagement portion and a pair of lateral support portions, the central engagement portion forming a right angle, the central engagement portion being configured to selectively engage a burner heat shield of a gas grill; and
a pair of charcoal supports coupled to each of the plurality of mounting rods, the pair of charcoal supports being coupled to the pair of lateral support portions, each of the pair of charcoal supports having an internal side and an external side, each of the pair of charcoal supports being V-shaped with the internal side perpendicular the external side, each of the internal side and the external side having a plurality of perforations, each of the plurality of perforations being circular, the plurality of perforations being colinearly aligned, each of the pair of charcoal supports being configured to hold a plurality of charcoal briquettes.
